(19) United States
(12) Patent Application Publication
(10) Pub. No.: US 2008/0043931 A1
(43) Pub. Date: Feb. 21, 2008

(54) Calibration system for telephone

(75) Inventors: James C. Steele, Chandler, AZ (US); Harold Downey, Tempe, AZ (US)

Correspondence Address: Paul F. Wille, 6407 East Clinton St., Scottsdale, AZ, 85254, US

(73) Assignee: Acoustic Technologies, Inc., Mesa, AZ (US)

(21) Appl. No.: 11/497,929

(22) Filed: Aug. 1, 2006

(51) Int. Cl. H04M 3/22

(52) U.S. Cl. 379/27.03

(57) ABSTRACT

An audio processor for two way communication includes a signal generator for producing test signals coupled to selected test points in the audio processor. An echo canceling circuit and a voice detection circuit within the audio processor provide data representing the response of the audio processing circuit to said test signals. The test signals include a single tone signal and a sweep frequency signal. Data from the test is used for adjusting the audio processor according to the results of the tests.

### BACKGROUND OF THE INVENTION

This invention relates to a telephone having a loudspeaker and having circuitry for echo cancellation and noise reduction and, in particular, to circuitry for calibrating such a telephone.

As used herein, “telephone” is a generic term for a communication device that utilizes, directly or indirectly, a dial tone from a licensed service provider. As such, “telephone” includes desk telephones (see FIG. 1), speakerphones (see FIG. 2), and hands-free kits (see FIG. 3). For the sake of simplicity, the invention is described in the context of telephones, and in particular a hands-free kit, but can be used in any two way communication system; e.g. intercoms in banks, fast food restaurants, or intensive care units in hospitals. In other words, reference to a hands-free kit is for the sake of readability and is not meant as a limitation on use of the invention.

As used herein, “loudspeaker” refers to the transducer itself and is not intended to imply any particular size, power rating, or type of enclosure. Nor is the term intended to imply any particular mechanism; e.g. electromagnetic, electrostatic, or piezoelectric. The term is simply used to distinguish from a “speaker,” a person who may be speaking.

There are many sources of noise in a telephone system. Some noise is acoustic in origin while other noise is electronic, from the telephone network, for example. As used herein, “noise” refers to any unwanted sound, whether the unwanted sound is periodic, purely random, or somewhere in-between. As such, noise includes background music, voices of people other than the desired speaker, tire noise, wind noise, and so on. As thus broadly defined, noise could include an echo of the speaker's voice. However, echo cancellation is treated separately in a telephone.

In addition to noise, the electrical and physical characteristics of the system can affect or “color” the sound of a person's voice. It has long been known in the art to provide some sort of calibration, for headsets, e.g. U.S. Pat. No. 4,788,708 (Hendrix), and for speakerphones, e.g. U.S. Pat. No. 4,887,288 (Erving). The Hendrix patent discloses a stand alone unit for testing headsets. The test stimuli and responses are all generated externally. This means that the device under test and test station must be physically near each other, which is not always convenient. Also, the test conditions are usually different from operating conditions.

The Erving patent describes a speakerphone with a self-calibration circuit included in the speakerphone. The speakerphone disclosed in the Erving patent is voice activated; i.e. the speakerphone does not operate in full duplex.

In view of the foregoing, it is therefore an object of the invention to provide a method and apparatus for testing or calibrating a hands-free kit.

Another object of the invention is to provide a method and apparatus for testing or calibrating hands-free kit by way of a computer.

A further object of the invention is to test or calibrate a hands-free kit by generating stimuli and sensing responses with the device under test itself.

Another object of the invention is to provide a method and apparatus for tuning the mechanical elements of a hands-free kit.

A further object is to provide a method and apparatus for testing a hands-free kit remotely, such as by wireless interface.

### SUMMARY OF THE INVENTION

The foregoing objects are achieved in this invention in which an audio processor for two way communication includes a signal generator for producing test signals coupled to selected test points in the audio processor. An echo canceling circuit and a voice detection circuit within the audio processor provide data representing the response of the audio processing circuit to said test signals. The test signals can include a single tone signal, multi-tone signals, a sweep frequency signal, white noise and/or recorded voice signals. Data from the tests is used for adjusting the audio processor according to the results of the tests.

### BRIEF DESCRIPTION OF THE DRAWINGS

A more complete understanding of the invention can be obtained by considering the following detailed description in conjunction with the accompanying drawings, in which:

FIG. 1 is a perspective view of a desk telephone;

FIG. 2 is a perspective view of a conference phone or a speakerphone;

FIG. 3 is a perspective view of a hands-free kit;

FIG. 4 is a perspective view of a cellular telephone (“cellphone”);

FIG. 5 is a block diagram of the major components of a cellular telephone;

FIG. 6 is a detailed block diagram of an audio processing circuit constructed in accordance with a preferred embodiment of the invention;

FIG. 7 illustrates the effect known as echo return loss;

FIG. 8 is a block diagram of a calibration system constructed in accordance with a preferred embodiment of the invention;

FIG. 9 is a block diagram of a calibration system constructed in accordance with an alternative embodiment of the invention;

FIG. 10 is a flowchart of a process for calibrating a hands-free kit in accordance with the invention; and

FIG. 11 is a screen shot of the second step illustrated in FIG. 10.

Those of skill in the art recognize that, once an analog signal is converted to digital form, all subsequent operations can take place in one or more suitably programmed microprocessors. Reference to “signal,” for example, does not necessarily mean a hardware implementation or an analog signal. Data in memory, even a single bit, can be a signal. In other words, a block diagram can be interpreted as hardware, software, e.g. a flow chart or an algorithm, or a mixture of hardware and software. Programming a microprocessor is well within the ability of those of ordinary skill in the art, either individually or in groups.

### DETAILED DESCRIPTION OF THE INVENTION

This invention finds use in many applications where the electronics is essentially the same but the external appearance of the device may vary. FIG. 1 illustrates a desk telephone including base 10, keypad 11, display 13 and handset 14. As illustrated in FIG. 1, the telephone has speakerphone capability including loudspeaker 15 and microphone 16.

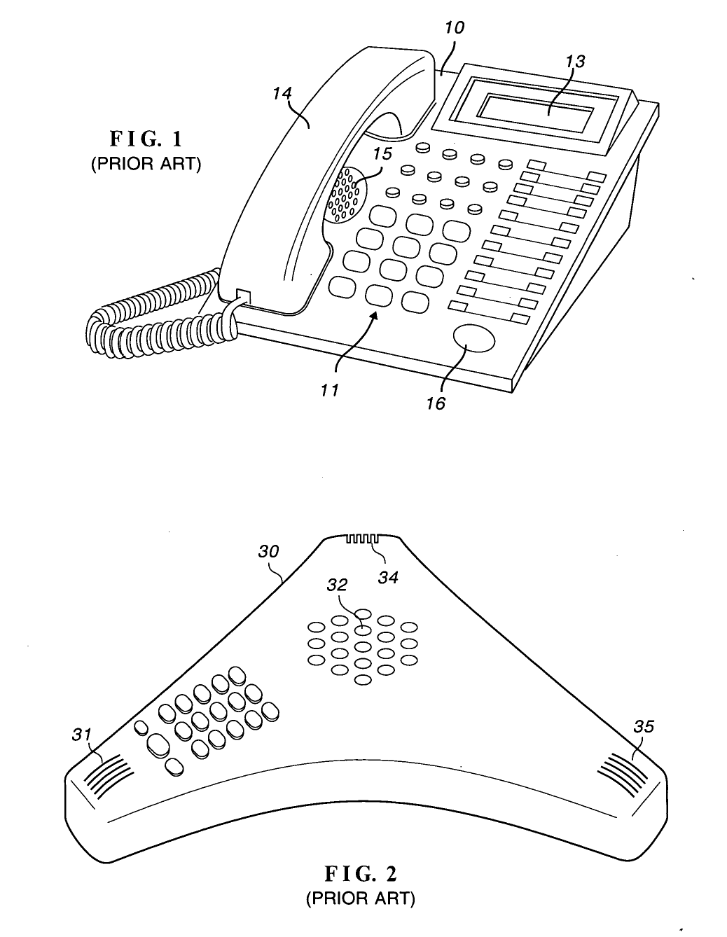

FIG. 2 illustrates a conference phone or speakerphone such as found in business offices. Telephone 30 includes microphone 31 and loudspeaker 32 in a sculptured case. Telephone 30 may include several microphones, such as microphones 34 and 35 to improve voice reception or to provide several inputs for echo rejection or noise rejection, as disclosed in U.S. Pat. No. 5,138,651 (Sudo).

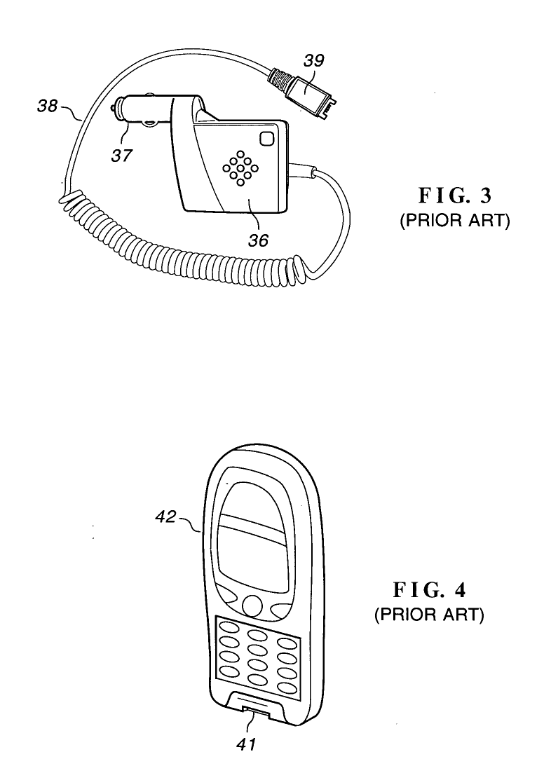

FIG. 3 illustrates what is known as a hands-free kit for providing audio coupling to a cellular hands-free kit, illustrated in FIG. 4. Hands-free kits come in a variety of implementations but generally include powered loudspeaker 36 attached to plug 37, which fits an accessory outlet or a cigarette lighter socket in a vehicle. A hands-free kit also includes cable 38 terminating in plug 39. Plug 39 fits the headset socket on a cellular telephone, such as socket 41 (FIG. 4) in cellular telephone 42.

In a sense, a hands-free kit is a special kind of speakerphone and comments relating to one should not be interpreted as excluding the other unless referring to a unique characteristic. A hands-free kit typically includes a volume control and some control switches, e.g. for going “off hook” to answer a call. A hands-free kit may include a visor microphone (not shown) that plugs into the kit. Some hands-free kits use “wireless” or RF signals, such as the “BlueTooth®” interface, to couple to a telephone.

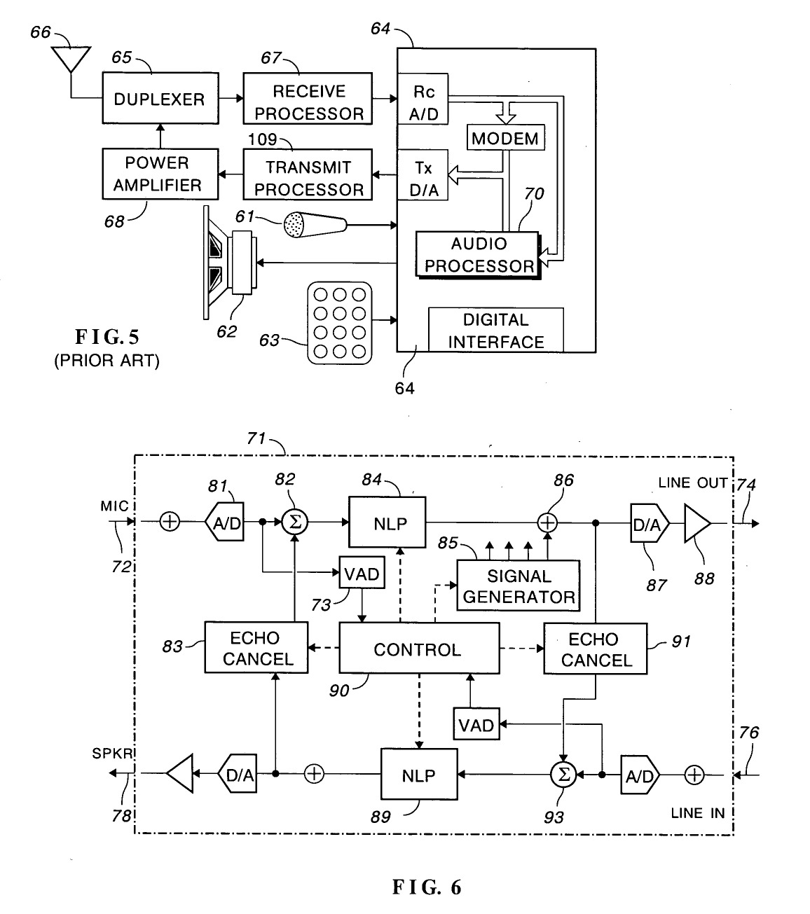

FIG. 5 is a block diagram of the major components of a cellular telephone. Typically, the blocks correspond to integrated circuits implementing the indicated function. Microphone 61, speaker 62, and keypad 63 are coupled to signal processing circuit 64. Circuit 64 performs a plurality of functions and is known by several names in the art, differing by manufacturer. For example, Infineon calls circuit 64 a “single chip baseband IC.” QualComm calls circuit 64 a “mobile station modem.” The circuits from different manufacturers obviously differ in detail but, in general, the indicated functions are included.

A cellular telephone includes both audio frequency and radio frequency circuits. Duplexer 65 couples antenna 66 to receive processor 67. Duplexer 65 couples antenna 66 to power amplifier 68 and isolates receive processor 67 from the power amplifier during transmission. Transmit processor 69 modulates a radio frequency signal with an audio signal from circuit 64. In non-cellular applications, such as speakerphones, there are no radio frequency circuits and signal processor 64 may be simplified somewhat. Problems of echo cancellation and noise remain and are handled in audio processor 70.

FIG. 6 is a block diagram of audio processing circuit 71, constructed in accordance with a preferred embodiment of the invention. The following describes signal flow through the transmit channel, from MIC input 72 to LINE OUT 74. The receive channel, from LINE IN 76 to SPKR output 78, works in the same way.

A new voice signal entering input 72 may or may not be accompanied by a signal from output 78. The signals from input 72 are digitized in A/D converter 81 and coupled to summation network 82. There is, as yet, no signal from echo canceling circuit 83 and the data proceeds to non-linear processor 84, which is initially set to minimum attenuation.

The output from non-linear processor 84 is converted back to analog form by D/A converter 87, amplified in amplifier 88, and coupled to output 74. Data from the two VAD circuits is supplied to control 90, which uses the data for controlling echo elimination and other functions. Circuit 83 reduces acoustic echo and circuit 91 reduces line echo. The operation of these last two circuits is known per se in the art.

In accordance with the invention, audio processing circuit 71 includes signal generator 85 that is selectively coupled to one or more test points within audio processing circuit 71. The test points are represented by a “+” sign within a circle in FIG. 6 and signal generator 85 is shown coupled to test point 86. Signal generator 85 is controlled by control circuit 90.

In accordance with another aspect of the invention, signal generator 85 can be the same circuit used for generating DTMF (dual tone multi-frequency) signals or a separate circuit, such as a white noise generator. Signal generator 85 generates tones for testing, including a sweep frequency signal for some tests. A sliding tone is obtained by sequentially changing data in a register to produce progressively increasing, or decreasing, pitch. The change is incremental, not continuous, but the incremental change is sufficiently small not to matter. Similarly, a sine wave is approximated in a digital circuit by incremental changes in amplitude. An internal linear feedback shift register can be used as a psuedo-random, white noise generator.

In accordance with another aspect of the invention, the audio processor is used to test the mechanical and acoustical aspects of a hands-free kit. This enables a system designer to optimize the performance of the enclosure and transducers in the enclosure, typically permitting a higher degree of full duplex operation.

The mechanical and acoustical aspects include loudspeaker response and distortion, microphone response, echo to near end speech ratio (ENR), acoustic echo return loss (ERL), and line interface characteristics (if applicable). These tests are important and desired because the tests can identify mechanical or acoustic problems that may prevent the system from achieving acceptable performance. The tests are also used to optimize voice quality and obtain maximum loudness without significant distortion. The process will enable a customer to achieve a higher level of system performance by helping him to improve the design of his enclosure and the selection of his transducers.

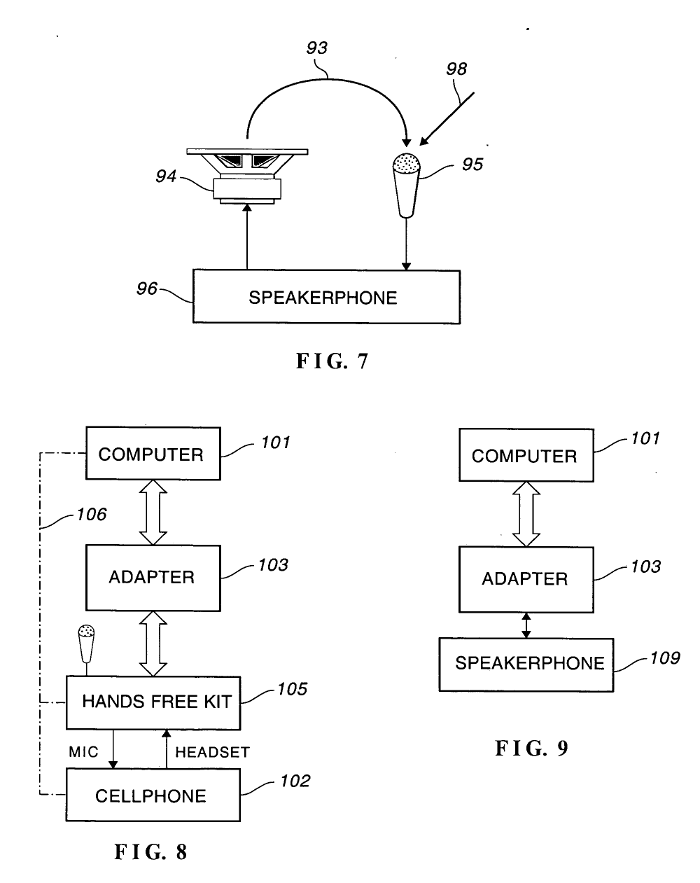

As illustrated in FIG. 7, Echo Return Loss (ERL) is the amount of coupling, represented by arrow 93, from loudspeaker 94 to microphone 95 in speakerphone 96. The coupling can be acoustical, mechanical or electrical. An ERL that is flat across the frequency range of interest is preferred. Spikes in the ERL can result from case rattles, the frequency response of the loudspeaker, or other non-linearities. ERL can be improved by separating the microphone and loudspeaker as much as possible, aiming the loudspeaker away from microphone, reducing mechanical coupling, e.g. by soft mounting the loudspeaker and microphone, sealing all air paths from the microphone to the loudspeaker, and by electronically compensating for transducer response.

Echo to Near end speech Ratio (ENR) is the ratio of Echo Power to Near End Speech Power as measured at the microphone and represented by arrow 98. Improved ENR will directly improve performance during double talk (both parties speaking). The ENR measurement is independent of microphone sensitivity or preamp gain. Maximum loudness should be used for an accurate measurement of ENR. Low values of ENR provide satisfactory full duplex performance. If the system does not have a low ENR, ERL should be reduced as described above. Specific values are system dependent and easily determined empirically. Measuring ENR is useful, for example, in diagnosing problems with the plastics, electronics, transducers, or the enclosure of a hands-free kit.

A repeatable stimulus is desirable. The stimulus can be a sine wave (tone), recorded speech, or white noise. Preferably, one plays a “.wav” file with a range of speech or noise on a computer. Recorded tones could be used also. The stimulus is inherently repeatable because it is recorded, or computer generated. To obtain a relatively standardized voice signal, automated voice menus are recorded as “.wav” files.

One embodiment of the hardware for calibrating is illustrated in FIG. 8. Computer 101 is coupled to hands-free kit 105 by way of adapter 103. Hands-free kit 105 includes the audio processing circuit illustrated in FIG. 6. In one embodiment of the invention, adapter 103 includes a USB (Universal Serial Bus) connection to computer 101 and a two wire serial bus connection to hands-free kit 105. Hands-free kit 105 and cellphone 102 communicate in the usual manner, as indicated by the (analog) lines interconnecting “MIC” and “HEADSET.”

The connection through adapter 103 is a control interface for sending commands to hands-free kit 105. Computer 101 and hands-free kit can also be coupled by bidirectional data bus 106 for injecting test signals. This bidirectional data bus can be wired or wireless, such as “Bluetooth” ®.

Another embodiment of the hardware for calibrating is illustrated in FIG. 9. Computer 101 is coupled to speakerphone 109 by way of adapter 103. A wireless interface can be used instead of adapter 103. Speakerphone 109 includes the audio processing circuit illustrated in FIG. 6.

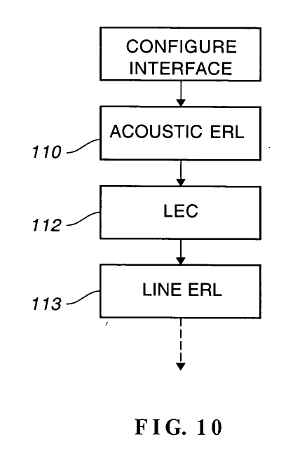

A process for calibrating a speakerphone or hands-free kit is illustrated in FIG. 10. In the audio processing circuitry, there are a plurality of registers for storing variable data and default data when the system is first turned on. The data can represent magnitude, thresholds, amplifier gain, filter coefficients, and the like. The hands-free kit being calibrated is able to monitor and to measure the signals applied to it or produced by it.

Referring to FIG. 10, as a first step, the interface is calibrated by adjusting the gains of the inputs and outputs of the audio processor. For example, one measures line output to make sure that the maximum output signal matches the rating for maximum input'signal of the device attached to line output.

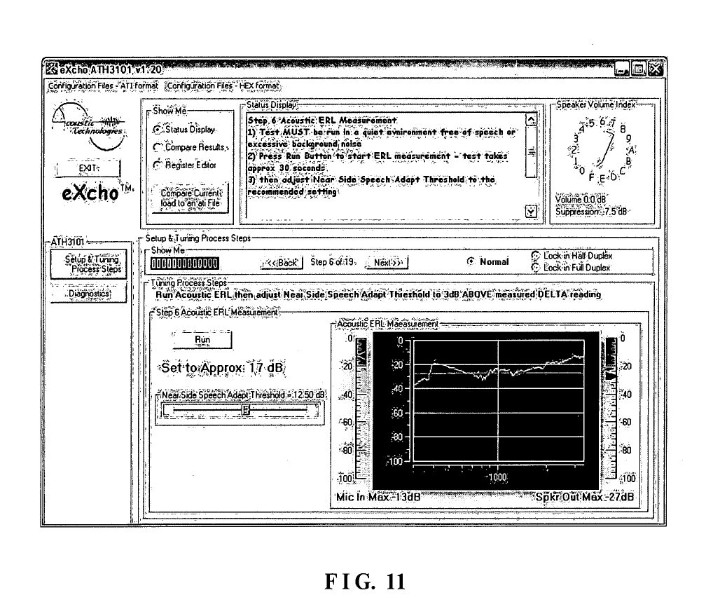

The next step is to measure ERL, as indicated at block 110. A “screen shot” of a computer display is illustrated in FIG. 11. As indicated in FIG. 11, the test is conducted with the loudspeaker operated at full volume (level “F”). This enables one to measure the echo path and to adjust the microphone input to avoid clipping. The room should be quiet while the test takes place. A sweep frequency stimulus is applied to the speaker while monitoring the amplitude of the signal at the MIC input (e.g. with VAD 73, FIG. 6). The response is presented graphically on a screen. The user is then advised whether or not to adjust the near side adapt threshold (an internal system parameter). Another step would similarly test for clipping at the MIC input. If clipping is detected, one should reduce case vibration, reduce microphone gain, or reduce loudspeaker gain, preferably in the order listed.

Referring to block 113 in FIG. 10, line ERL is measured. This is the same test as in block 110, only for the line input instead of the MIC input and using the line output instead of the speaker output. Depending upon the capabilities of the particular device under test, additional tests can be performed using a wireless or wired link to the device. Such tests include adjusting the threshold for switching between half duplex and full duplex mode, adjusting noise cancellation, and adjusting the frequency response of the transmit channel and the receive channel.

The following data is given by way of example, not as a limit on signal levels, which depend upon the particular system being tested. A digital full-scale sine wave produces a signal level of −4 dB. Any signal above this level will typically be distorted due to saturation. For speech, a peak of −12 dB is a useful the full-scale limit.

The invention thus provides a method and apparatus for testing or calibrating a hands-free kit by way of a computer. The hands-free kit itself generates stimuli and senses responses. The testing enables one to tune the mechanical elements of a hands-free kit. The testing can be conducted remotely, such as by wireless interface.

Having thus described the invention, it will be apparent to those of skill in the art that various modifications can be made within the scope of the invention. For example, the mention of USB and BlueTooth® interfaces is not intended to be exhaustive of the manner in which signals can be coupled to the system under test. Simulating actual conditions as closely as possible is desired. For example, if a transmission line simulator is available, it can be included to simulate various lengths of line between a telephone and a switching station. Computer 101 can be a programmed personal computer or a test apparatus dedicated to calibrating hands-free kits or speakerphones. Signal generator 85 can have plural outputs individually coupled to test points by amplifiers whose gain is adjustable or can be coupled by a multiplex circuit to the test points. Either way, the coupling is selective.

What is claimed as the invention is:

1. In an audio processor for two way communication, the improvement comprising:
a signal generator for producing test signals coupled to selected test points in the audio processor.

2. The audio processor as set forth in claim 1 wherein said audio processor includes an echo canceling circuit and a voice detection circuit and wherein said echo canceling circuit and voice detection circuit provide data representing the response of the audio processing circuit to said test signals.

3. The audio processor as set forth in claim 1 wherein said test signals include a single tone signal.

4. The audio processor as set forth in claim 1 wherein said test signals include a sweep frequency signal.

5. The audio processor as set forth in claim 1 wherein said test signals include white noise.

6. Apparatus for testing a telephone, said apparatus comprising:
a computer;
an interface coupled to the computer;
a telephone coupled to the interface;
an audio processor circuit in said telephone, said audio processor including a signal generator controlled by said computer for producing test signals coupled to selected test points in the audio processor.

7. The apparatus as set forth in claim 6 wherein said audio processor includes an echo canceling circuit and a voice detection circuit and wherein said echo canceling circuit and voice detection circuit provide data to said computer representing the response of the audio processing circuit to said test signals.

8. The apparatus as set forth in claim 7 wherein said telephone and said computer each include a wireless interface and said data is coupled to said computer by way of said wireless interface.

9. The audio processor as set forth in claim 6 wherein said test signals include a single tone signal.

10. The audio processor as set forth in claim 6 wherein said test signals include a sweep frequency signal.

11. The audio processor as set forth in claim 6 wherein said test signals include white noise.

12. A method for calibrating a telephone, said method including the steps of:
coupling the telephone to a computer by way of an interface;
configuring the telephone to produce standardized signal levels;
applying test signals to test points the telephone;
receiving data signals from the telephone indicative of at least one parameter under test; and
adjusting the operation of the telephone in accordance with the data signals.

13. The method as set forth in claim 12 wherein the test signals are prerecorded voice signals.

14. The method as set forth in claim 12 wherein the test signals are generated within the telephone.

15. The method as set forth in claim 12 wherein the at least one parameter is acoustic echo return loss.

16. The method as set forth in claim 12 wherein the at least one parameter is echo to near end speech ratio.
